(19) United States
(12) Patent Application Publication
(10) Pub. No.: US 2015/0026009 A1
(43) Pub. Date: Jan. 22, 2015

(54) CONTEXTUAL BASED WIFI APPLICAITON

(71) Applicant: SmartZeit, Inc., Irvine, CA (US)

(72) Inventor: Sanjay Mishra, Irvine, CA (US)

(21) Appl. No.: 13/794,746

(22) Filed: Jul. 16, 2013

(51) Int. Cl. G06Q 30/06; G06Q 20/32; G06Q 20/02; G06Q 20/12

(52) U.S. Cl. CPC G06Q 30/0613; G06Q 20/12; G06Q 20/32; G06Q 20/02
USPC 705/26.41

(57) ABSTRACT

The invention relates to electronic communication between entities via a transient contextual interaction channel (TCIC) that mirrors the real world nature of the short term interaction between two or more entities such as a consumer and business. The invention employs a mobile phone and a cloud based information system that is a real-time representation of a user's daily interaction with vendors and which provides users with the ability to acquire and respond to structured data concerning these activities.

### CROSS-REFERENCE TO RELATED APPLICATION

U.S. provisional application No. 61/691,796 filed on Aug. 22, 2012 entitled Credit Card Payment over Local Wi-Fi Network during physical visit to Business, Retail or Institutional Location; U.S. provisional application No. 61/688,011 filed on Jul. 4, 2012 entitled Dynamic Availment of Application Services hosted on Local Wireless WiFi or LiFi Network via a User's Mobile Computing Device's joining Local Wireless WiFi or LiFi Network, during physical visit to Business or Institution's premises; and, U.S. provisional application No. 61/609,294 filed on Mar. 10, 2012 entitled TRANSIENT CONTEXT BASED INTERACTION CHANNEL BETWEEN ENTITIES all of which are incorporated herein by reference.

### ABSTRACT

The invention relates to electronic communication between entities via a transient contextual interaction channel (TCIC) that mirrors the real world nature of interactions between two or more entities such as a consumer and business. The invention transforms a customer's smart phone into a dedicated self-server kiosk over the in-premise Wi-Fi network present at a retail vendor's store during the period of a customer's visit to a brick and mortar physical location. The system provides a real-time representation of a user's daily interaction with vendors and enables users to acquire and respond to structured data concerning these activities. Once established the transient contextual interaction channel can be maintained even after the customers leaves a vendor's store over a cellular network.

### FIELD OF THE INVENTION

For over a decade businesses and institutions have provided free Wi-Fi to customer's computing devices while customers were on the premises of the businesses brick and mortar location. Such Wi-Fi access has emphasized access to the internet. However, customers could benefit from additional on-premise services that could be offered over the Wi-Fi connection including general information, seat availability information, order placement, prices, specials as an example. So far the potential for Wi-Fi connectivity connectivity to serve as a channel for direct interaction between a customer's smart phone application and the businesses in store application services has been largely ignored. The present invention relates to an information exchange system that enables a contextual interaction channel (TCIC) between a user and a business, between two businesses or within a businesses. The contextual interaction channel provides a secure system that functions over both a local area network such as Wi-Fi and a wide area network such as GPRS. When a user enters the premises of a merchant's brick and mortar store the user's personal electronic device, such as a smartphone, connects to the merchant's local Wi-Fi network. User identification and financial account information is passed electronically from the user's electronic device to the merchant's on-site TCIC infrastructure. The user is validated over the merchant's network connection, such as a wired Internet connection, and authentication plus validation codes are passed back to the user along with structured data about the transient interaction, thereby establishing the contextual interaction channel for ongoing transactions between consumer and vendor.

### BACKGROUND OF THE INVENTION

Currently some business and institutions provide network and internet connectivity for their user and customers during their visit to the location. For instance a retail store such as a coffee shop may provide network connectivity for their customers computing devices, and the purpose is typically to access the Internet. While several inventions have previously been disclosed involving the use of mobile phones and interaction with businesses or other vendors including electronic reservation and payment systems, no system is currently available that enables a mobile phone user to interact and exchange a wide range of relevant information with a business over the entire course of the relationship. As a result of the fact that the entire range of interactions is not modeled in the contextual interaction channel, many ad hoc trips are made to various destinations resulting in traffic jams and sometimes disappointments from not being able find a table, or be seated in a reasonable amount of time. This trend is consistent with the facts that customer-vendor transactions have increasingly moved away from dependence upon physical proximity and synchronous person to person contact with exchange of hard currency. Drafts or “checks” first eliminated the need for hard currency and more recently online purchases with payment information transmitted electronically by credit card or through a payment service such as PayPal have become a regular occurrence. Recently, electronic devices, including smartphones, have gained the ability to store and transfer financial account information using contactless means such as near field communications (NFC) or radio-frequency identifications (RFID).

The current invention is a system and mechanism that enables an application protocol level interaction between applications on the user device with application services on the local network. Also, currently business and offices with physical locations use self-serve kiosks as well as human agents to assist walk-in customers and customers in their availing of services, and/or making purchases. The current invention transforms the user's own device into a self serve kiosk. This invention envisages a transient contextual interaction that is initiated over a Wi-Fi network. The present invention specifically pertains to “in-premise” consumer to business dynamic electronic interactions, interbusiness interactions, and intra-business interactions with minimal configuration, dynamic detection of customer arrival on premises by leveraging the in-premises Wi-Fi network using the technologies and methods described herein. The invention dynamically converts the consumer electronic device (CED) into a self-serve kiosk, once the consumer is on the premises and their smart phone has joined the “in-premise” local Wi-Fi or Li-Fi network. The present invention additional emphasizes a transient contextual interaction of “in premise” consumer to business or institution's services and facilities which mirrors the real world context. Additionally, the current invention concerns intra-business over the local private in-premise network when staff members are within the premises and need to collaborate their tasks and the work flow to carry out job functions and service customers. Specifically, it concerns customers or individuals visiting a retail or institution's physical brick and mortar premises, and their efficient and convenient interaction with the software services at a retail or institutional location provisioned over the local network and independent of any internet connection or a consumer electronic device's carrier signal. These software services and customer specific contexts mirror the real world interaction of the customer and the retail or institutional location. The present invention also pertains to intra business work flow as in when a partner business or institution's staff member visits a premise to carry out some business function such as delivery or repair and so on. In more general terms, beyond the optimization and streamlining of interactions and use of a contextual model, this invention applies also to construction sites with local Wi-Fi access points and staff devices, adhoc networks, in-ship and in-airplane interactions, across fleets of ships that move in formation where wireless access is maintained across the fleet. The only essential requirement is to have CDA's with Wi-Fi of Li-Fi capability and installed TCIC applications.

Once the application to application handshake between a consumer's mobile device and the merchants application services occurs, the user's own device transforms into a person self-serve kiosk. Using this system there is no need to form in a line in the store, there is no sharing of screens or menus with other customers or store staff. This promotes better efficiency and flow within the store as well as better efficiency and health. Thus, ordering services, acquiring resources, waiting, checking out, paying are all managed within a rich contextual application umbrella, rather than by loose SMS text message or phone calls or by standing in physical lines. The current invention requires the cooperation of three applications: a Consumer Mobile Self Serve Kiosk Application (CMSSKA), a Business Location Wi-Fi Access Point Extension Application (BLWAPEA) and a Business Location Staff Tablet Application (BLSTA). The current TCIC invention is not a location based service because it is geo-coordinate independent. It offers certain advantages over location based services since it affords improved consumer privacy with regard to the location of the consumer when consumers are not in the brick and mortar premises of a store. Any Wi-Fi capable phone can serve as a self-service kiosk, regardless of whether other carrier services exist or signal is available.

Thus, a transient contextual interaction channel that is a real-time representation of all of a users' daily interactions with vendors and which enables users to acquire and respond to structured data concerning these activities is needed. The first step of the process is to initialize and quickly establish the transient contextual interaction channel between entities. The process of channel creation occurs via multiple mechanisms including but not limited to channel-unique bar code creation and scanning, near field communications, as well as by email and text based invites to the intended channel participant entities. Invite and acceptance between entities that are parties to the channel is mediated by application logic on the cloud server side and by application logic also present on the device client side. The transient contextual interaction channel is primarily accessed via mobile devices. However it may also be accessed by a browser or by applications on a desk top computer. The channel is fed information by human inputs on the business or vendor side or by back end server systems that reflect real-world events and processes.

Once the TCIC is established the second step in the process is the two-way exchange of structured information such as status information, questions and answers between entities, forms and approvals, and any other relevant business work flows. This information is delivered by the use of dyna-forms which enable contextual information to be delivered. The data that may be exchanged includes images, audio, video, SMS and MMS. However this information is structured since it is delivered to users' mobile phones within the context of the application so a user knows exactly why a phone call or text is being received and does not have sort through random communications made to that device throughout a day. The delivery of structured contextual information is minimally invasive since the information flow is asynchronous and fully identified. The server side services support and maintain the entire channel state representation and the life cycle from creation, information updates and propagation and exchange as well as the eventual tear down of the channel. The server side services also create a level of anonymity that can insulate the user from having to disclose personally identifying information such as a phone number, yet simultaneously enable users to receive mobile phone communications from vendors through the use of number provisioning. The system uses a combination of application logic on the cloud server side and on the device client side to support the channel. Application servers and media servers provide supporting functionality. The third and final step of the process involves the tear down the transient interaction channel once the transaction is completed. This step may be initiated because the time-to-live has been reached, or because of the specific needs in each channel of the participants.

The current system has several important advantages over what has come before. One of the chief advantages of establishing a transient contextual interaction channel between customers and vendors is that ad hoc trips and attempts are minimized and the use of resources and time is optimized. There is a need to reduce traffic and the consequent air pollution that harm our environment, a need to increase client satisfaction, and a need to increase sales for the participating companies. Compared to NFC technology, which enables a secure exchange of information between devices over a very short distance (usually up to about four centimeters) and RFID payment systems which have similar distance limitations, the current system operates over a Wi-Fi Network at a distance of 100 meters. In addition none of the existing technologies addresses the entire scope of interactions that are present between a customer and a vendor. For example, when a customer enters a restaurant they must progress through a series of contextual state transitions including first establishing arrival and entry onto the premises, then seeking to be seated, customers may need to wait for a table, then respond to an indication that a table is available, then be seated and view a menu, order, eat, request more water, pay the bill, and then leave. Similarly, currently system use geo tracking constantly to determine if the user is near or at the location of the business retail store for instance. However, the present invention does not use geo location and is more respectful towards the user's privacy since the business or institution will not have access to the knowledge of the users location before and after the user's visit to the business or institution's premises.

### RELEVANT ART

US 2002/0092995 A1 Jun. 27, 2002 Payment Authorization System which enables users of mobile devices to approve or deny transactions.

US 2008/0294556 A1 Nov. 27, 2008 Mobile Commerce Service which enables secure transactions over wireless devices.

US 2012/0232917 A1 Sep. 13, 2012 System and Method for Wireless Reservation and Ordering from a Mobile Device which enables a location based service.

### BRIEF SUMMARY OF THE INVENTION

An object of the present invention is to provide a transient contextual interaction channel between customer and vendor entities.

Another object of the present invention is to provide a context based interaction channel between entities which enables a complete representation of all the contextual state transitions that a user will encounter in transacting with a given vendor.

Another object of the present invention is to provide a context based interaction channel between entities which enables secure payments from wireless devices.

Another object of the present invention is to provide a context based interaction channel that reduces the need for ad hoc trip and reduces instances of disappointed consumer expectations.

Another object of the present invention is to provide a context based interaction channel that reduces air pollution and traffic.

Yet another object for this invention is to provide a context based interaction channel between entities that increases business sales and efficiency.

The present invention achieves its objects by providing a context based interaction channel that enables a real time simulation of the entire transient state.

The manners in which the invention achieves its objects and other objects which are inherent in the invention will become more readily apparent when reference is made to the accompanying drawings wherein like numbers indicate corresponding parts throughout.

### BRIEF DESCRIPTION OF THE DRAWINGS

FIG. 1 is a block diagram of the transient contextual interaction system architecture according to the present invention.

FIG. 2 is a block diagram of the transient contextual interaction system architecture enabled for a gymnasium according to the present invention.

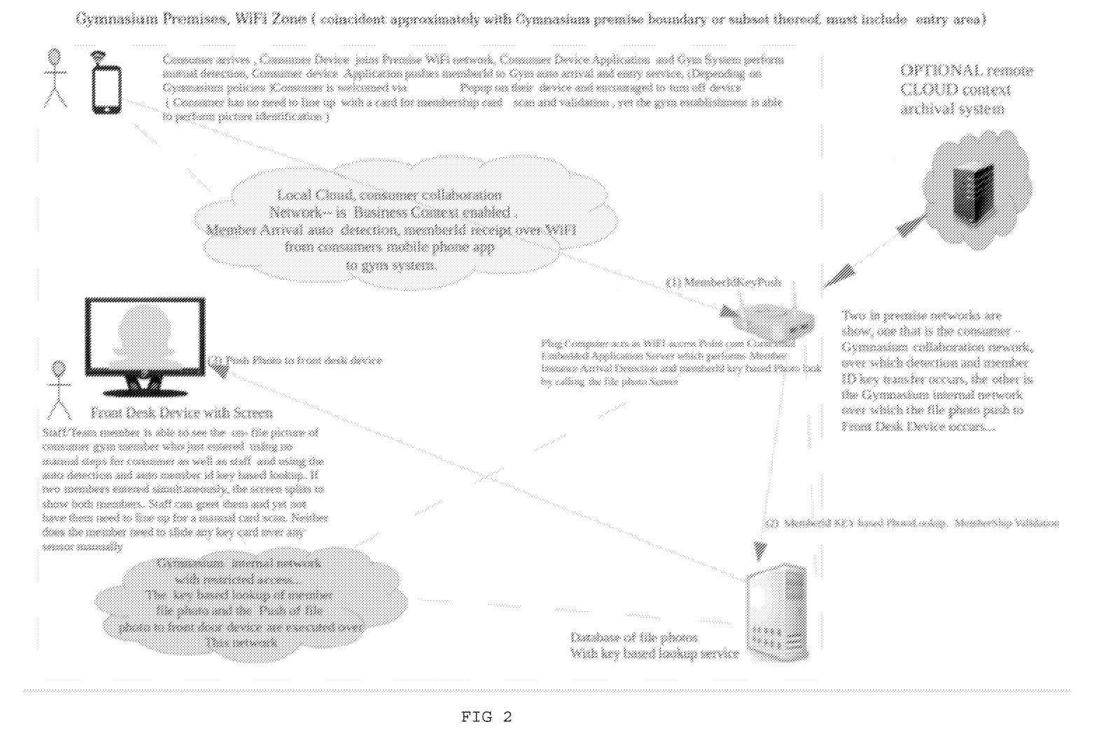

FIG. 3 is a block diagram of the transient contextual interaction system architecture according to the present invention.

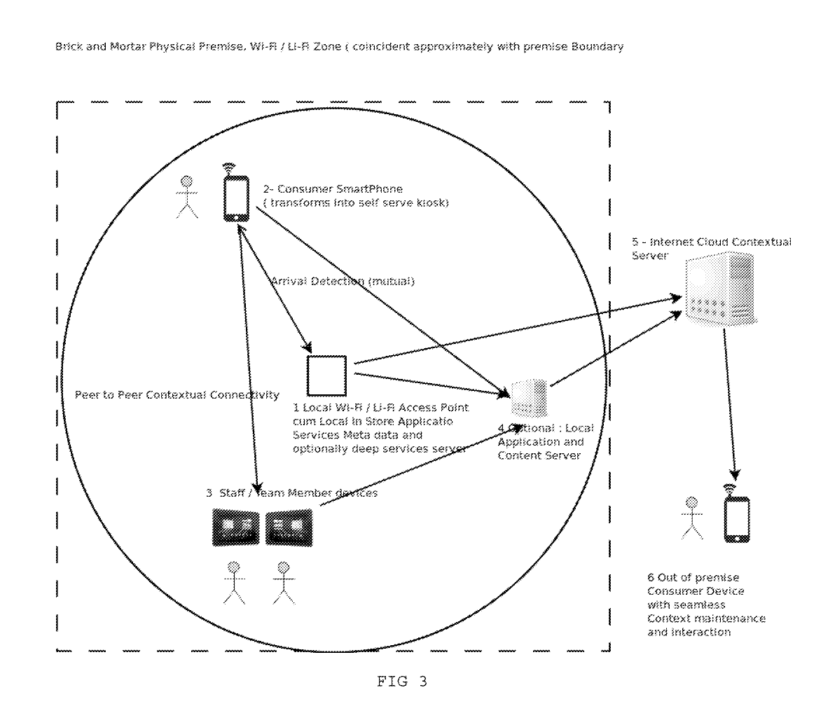

FIG. 4 is an exemplary user interface window of the Consumer Mobile Self Serve Kiosk Application enabled for a bank according to the present invention.

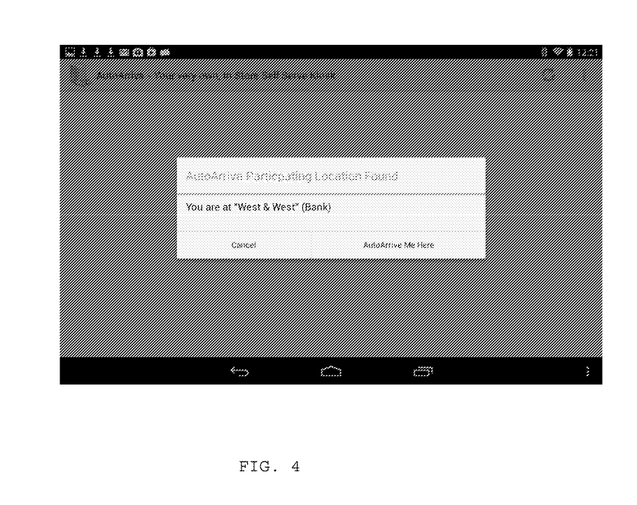

FIG. 5 is an exemplary user interface window of the Consumer Mobile Self Serve Kiosk Application enabled for a bank according to the present invention.

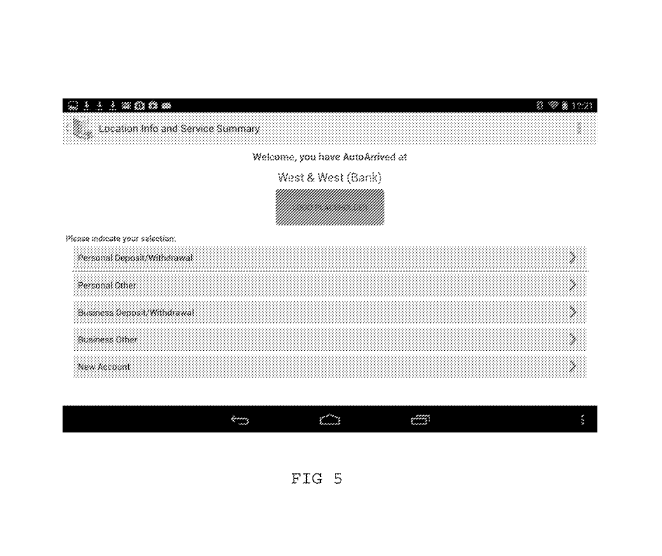

FIG. 6 is an exemplary user interface window of the Consumer Mobile Self Serve Kiosk Application enabled for a restaurant according to the present invention.

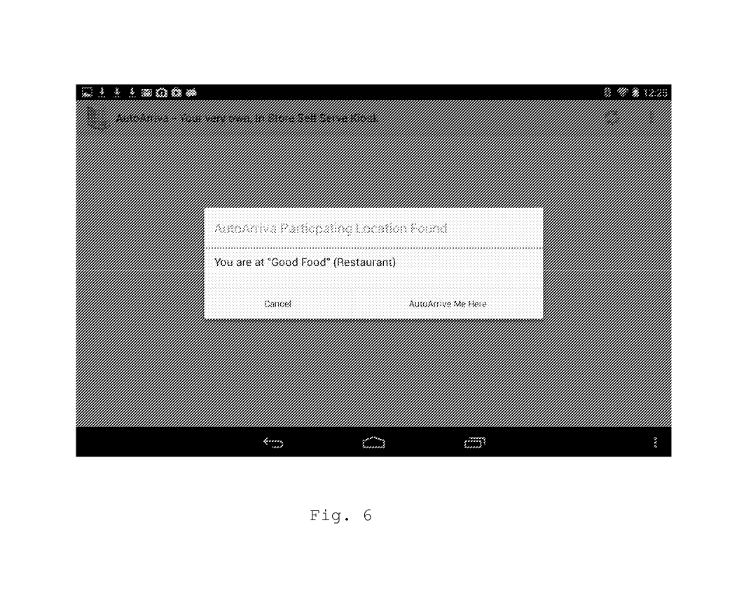

FIG. 7 is an exemplary user interface window of the Consumer Mobile Self Serve Kiosk Application enabled for a restaurant according to the present invention.

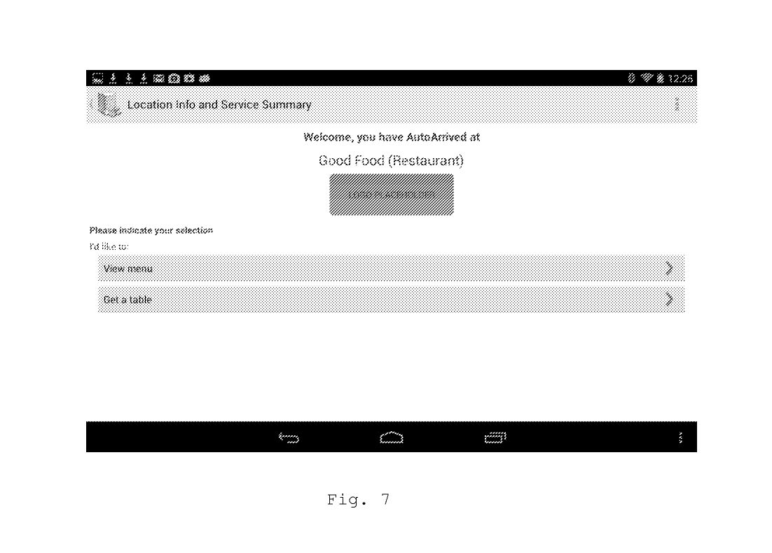

Similar reference characters denote corresponding features consistently throughout the attached drawings.

### DETAILED DESCRIPTION OF THE PREFERRED EMBODIMENTS

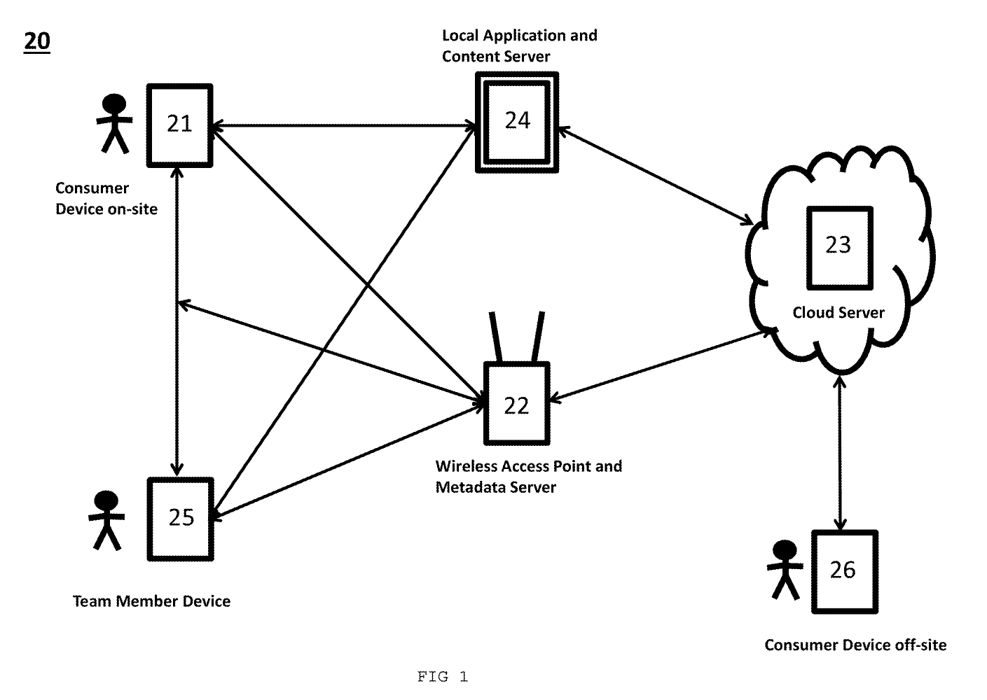

Referring now to the drawings wherein the showings are for purposes of illustrating a preferred embodiment of the present invention and not for purposes of limiting the same. First embodiment of the invention is a transient contextual interface channel (TCIC) 20 illustrated in FIG. 1. When the consumer electronic device (CED) 21, which may be a smartphone, tablet, laptop computer, or personal digital assistant enters the brick and mortal physical premises of the business, retail or institution, the consumer needs to make a one-time connection to the business in-premise Wi-Fi network. The mobile device 21 preferably includes a processor for processing executable instructions, a display coupled to the processor for displaying images and text, and a memory device arranged to store data. The mobile device 21 preferably has Wi-Fi capabilities. The user consumer device joins the premise Wi-Fi network by detecting the merchant's wireless access point 22 over multicast using the Business Location's Wi-Fi Access Point Extension Application (BLWAPEA). Once the user consumer device joins the in-premise Wi-Fi network, the Consumer Mobile Self Serve Kiosk Application (CMSSKA) performs a “participating location” scan to detect if the current network and business location is “participating location.” This participating location scan is accomplished by a combination of technologies including TCP and UDP scans, IP multicast scans, and predetermined post chains and multicast DNS scans. Once the CMSSKA detects that the local network represents a participating location, a two way application to application handshake is established between the three applications that work together: CMSSKA, BLWAPEA, and the Business Location Staff Tablet Application (BLSTA). A private network address is allocated to the user consumer device 21 and the TCIC is established.

Mutual arrival detection is one of the first steps in this transient contextual interaction whenever a consumer visits the physical premises of participating business. If the consumer's device fails to detect that the current location is participating business, the application shuts down and the consumer and business location will be unable to transact any interactions over the in-premise Wi-Fi. A mutual scan for application services occurs on both the consumer device and also on the business side access point by the local application meta data server. Contextual applications serve private network address and port, reflect the contextual state, on a two basis over a local cloud, and also supports structured application interaction working as the customers own dedicated self-serve kiosk. When a valid TCIC connection is made, the TCIC browser application on the user consumer device 21 provides a catalogue of permissible transactions include registration, item and service ordering, reservation making, and/or receiving special offers from participating vendors. The application to application, application protocol based method emphasizes asynchronous peer to peer communication which reflects the asynchronous nature of real world events, including in-store work flows.

Through the access point 22, the consumer device can send and receive information to the merchant which is connected to the wireless access point via a cloud server 23. The merchant can receive information either directly at the local server 24 or through a team member device 25, which may also be a smartphone, tablet, laptop computer, or personal digital assistant. The team member device runs the Business Locations Staff Tablet Application (BLSTA). The local server 24 contains metadata including prices for products and services. The local server 24 can also serve applications and content to the consumer device 21. When a user initiates a transaction through their device 21, financial account information is transmitted to the local server 24. The local server 24 transmits the financial account information securely over the merchant's wide area network, which in most cases will be the Internet. The local server 24 will receive payment authorization and authentication from the wide area network. The local server 24 will then transmit authentication and validation codes back to the consumer device 21. A receipt may also be transmitted to the consumer device 21.

A second embodiment of the invention is a TCIC 30 implemented for the purpose of enabling a gymnasium. When the consumer electronic device (CED) 31 enters the brick and mortar physical premises of the gymnasium, the CED 31 joins the in-premise Wi-Fi network, and the consumer device application and gym system perform mutual detection. The consumer device application pushes the member ID to the Gym auto-arrival and entry service through the local cloud Wi-Fi system. The member ID key is transmitted to a contextual embedded application server which performs member instance arrival detection and member ID key lookup based upon a photo stored in the photo file server. Once the consumer's file is and photograph are located, the information is sent to the front desk device which displays the consumers photo. The staff member is able to see the on-file picture of consumer/gym member who just entered. There are no manual steps for the consumer or for staff. The Consumer is then welcomed by a pop-up window on their device and encouraged to turn the device off. This procedure enables the consumer to avoid standing in line to present a membership card for scanning and validation. In the event that two members enter simultaneously, the staff member's display goes to a split screen mode and shows both members.

A third embodiment of the invention is a TCIC 40 implemented for the purpose of enabling a pool side hotel environment. When the CED 41 enters the physical premises of the pool area it joins the in-premise Wi-Fi network, and the mutual detection routine is initiated. The consumer device application pushes the hotel guest identification number or room number through the local cloud Wi-Fi system to the contextual embedded application server which performs the arrival detection and hotel guest validation routine based upon information stored in a Guest identification file server. Once located the guest is then welcomed by a pop-up window on their device and offered a range of hotel services including the ability to order meals to the poolside, order additional towels or to access other hotel services such as making dinner or massage reservations. Alternatively, the pool side hotel environment could be envisaged to be on remote island resort get aways, yachts, cruise ships or other luxury environments where extra prompt service is expected by patrons.

A fourth embodiment of the invention is a TCIC 50 implemented for the purpose of enabling a automotive repair shop. When the CED 51 enters the physical premises of the auto repair shop it joins the in-premise Wi-Fi network, and the mutual detection routine is initiated. The system then matches the CED 51 and consumer with the pre-scheduled appointment if there is one and enables the user to communicate what services he requires to the repair shop before directly communicating with service staff. The invention does not replace the consumer's interaction with service staff it merely complements it and further enables a paperless record of the to be created regarding the items and services ordered, along with any related acknowledgements, sign offs and estimates. After the consumer leaves the auto repair shop, the consumer would like to have information as to when the vehicle will be ready. Rather than have the consumer repeatedly call the repair shop, or have the repair shop repeatedly call the consumer as the process of servicing the car proceeds, the current invention enables a pop-up screen to appear when the car is ready. In addition, should additional authorizations or approvals be needed during the course of the servicing the car, these notifications would also flow to the CED 51 enabling the user to approve items on an itemized basis.

The present invention has been described as specific embodiments that provide for transient contextual interaction channels. Additional modifications and improvements of the present invention may also be apparent to those of ordinary skill in the networking and computing arts. In fact, many embodiments and implementations are possible. These embodiments and the following claims are not intended to serve as limitations of alternative devices within the spirit and scope of the invention.

We claim:

1. A method, apparatus, hardware and software system comprising of ARM plug computer based Wireless Access point cum application protocol services hosted within the business or institutions' physical brick and mortar premises which provide both IP network connectivity and application protocol level connectivity between the visiting in-store Consumers Mobile devices with appropriate applications installed.

2. A method as cited in claim 1 that further comprises a method that enables the Consumer's Mobile device and software application therein to detect arrival at a participating physical store location, and be detectable as a customer arrival by the in-store tablet based applications and access point extension application services.

3. A method as cited in claim 1,2, that further implements application protocols that support a dynamic handshake and exchange of service meta-data between the participating entities including consumer's mobile application, staff tablet application, and access point application services.

4. A method as cited in claims 1,2,3 that further comprises a mechanism to create, maintain and tear down a transient real world business context based interaction between the participants such as consumer and business as well as business to business.

5. A method as cited in claims 1,2,3,4 that further enables the in- premise consumer's smart phone device and software application therein to transform the consumer's smart phone into a self serve kiosk.

6. A method as cited in claims 1,2,3,4,5 that further enables the consumer's device acting as a self serve kiosk to provide the consumer with in-store customer service, access to general information, get specific questions answered, access service, product, pricing, discount information, place orders, receive in-application contextual status transitions and rich in-application notifications all via the customers own device and over the in store, in- premise Wi-Fi network.

7. A method as cited in claims 1,2,3,4,5,6 that further enables the consumer's device acting as a self serve kiosk to serve as a self pay application to make payments via application user interfaces for in store product and service purchases over the Wi-Fi network using the application protocols described herein.

8. A method as cited in claims 1,2,3,4,5,6 that further enables the store side application to receive the credit card information, validate and authorize it via accessing third party remote internet based credit card payment services and respond back to the customer device with a receipt and proof of payment.
